(19) United States
(12) Patent Application Publication
(10) Pub. No.: US 2019/0004822 A1
(43) Pub. Date: Jan. 3, 2019

(54) DYNAMIC CONFIGURATION OF USER INTERFACE ELEMENTS

(71) Applicant: Verizon Patent and Licensing Inc., Basking Ridge, NJ (US)

(72) Inventors: Kevin LISEWSKI, Ramsey, NJ (US); Mica BARD, West Orange, NJ (US); Erin REEG, Stony Point, NY (US); Nathaniel DRAPIZA, Wyckoff, NJ (US); Zachariah NELSON, Clayton, NJ (US)

(21) Appl. No.: 15/639,551

(22) Filed: Jun. 30, 2017

(51) Int. Cl. G06F 9/44; G06F 3/0481

(52) U.S. Cl. CPC G06F 9/4443; G06F 3/0481

(57) ABSTRACT

A device can receive information associated with dynamically configuring a set of user interface elements associated with a user interface. The device can process the information to determine a manner in which to configure one or more subsets of user interface elements, of the set of user interface elements. The one or more subsets of user interface elements can relate to displaying sports-related information, displaying location-based information, navigating through one or more user interfaces, a homepage user interface, displaying an advertisement, or displaying live content. The device can perform an action to cause the one or more subsets of user interface elements to be configured in the determined manner. The device can detect a modification to the information after performing the action. The device can modify the manner in which the one or more subsets of user interface elements are to be configured based on the modification to the information.

### BACKGROUND

A display of a user device can display a user interface (e.g., a graphical user interface). A user interface can permit interactions between a user of the user device and the user device. In some cases, the user can interact with the user interface to operate and/or control the user device to produce a desired result. For example, the user can interact with the user interface of the user device to cause the user device to perform an action. Additionally, the user interface can provide information to the user. Further, a user interface can include various user interface elements, such as buttons, toggles, embedded content, controls, text boxes, labels, and/or the like.

### BRIEF DESCRIPTION OF THE DRAWINGS

FIGS. 1A-1D are diagrams of an overview of an example implementation described herein;

FIG. 2 is a diagram of an example environment in which systems and/or methods, described herein, can be implemented;

FIG. 3 is a diagram of example components of one or more devices of FIG. 2;

FIG. 4 is a flow chart of an example process for dynamic configuration of user interface elements;

FIGS. 5A-5E are diagrams of an example implementation relating to the example process shown in FIG. 4;

FIG. 6 is a call flow diagram of an example call flow for dynamic configuration of user interface elements; and

FIG. 7 is a diagram of an example implementation relating to the example process shown in FIG. 4.

### DETAILED DESCRIPTION OF PREFERRED EMBODIMENTS

The following detailed description of example implementations refers to the accompanying drawings. The same reference numbers in different drawings can identify the same or similar elements.

A user interface can include various sets of user interface elements. For example, a user interface can include a first set of user interface elements to embed content on a user interface, a second set of user interface elements to provide navigation controls, a third set of user interface elements to display advertisements, and/or the like. Configuring each of the sets of user interface elements based on different information can enhance usability of the user interface through customization and/or elimination of un-needed user interface elements. A device, such as a user device, can lack a technique for dynamically configuring various sets of user interface elements based on information from multiple different sources.

Some implementations, described herein, provide a device that can process information from multiple different sources and can dynamically configure various sets of user interface elements based on the information. In this way, the device dynamically configures the various user interface elements in real-time, thereby improving use of a user interface. This conserves processing resources that would otherwise be consumed providing un-needed user interface elements for display, via selection of user interface elements that are not needed for a particular use (e.g., via accidental selection by a user of the user interface), and/or the like. In addition, this enhances a user experience of a user of the user interface via dynamic configuration of various sets of user interface elements for particular uses, particular needs, and/or the like.

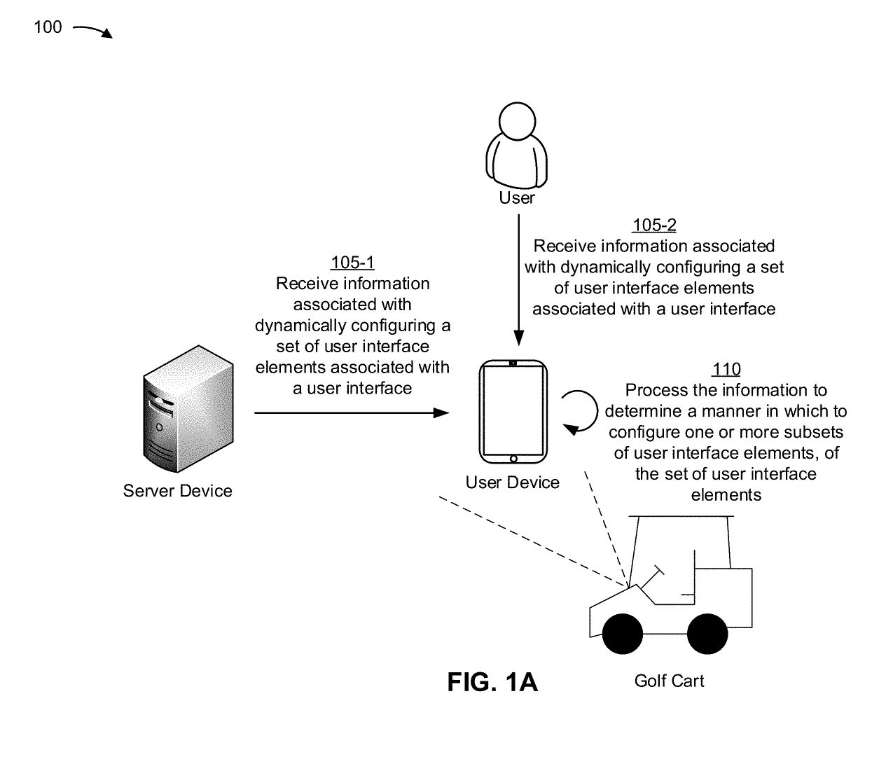

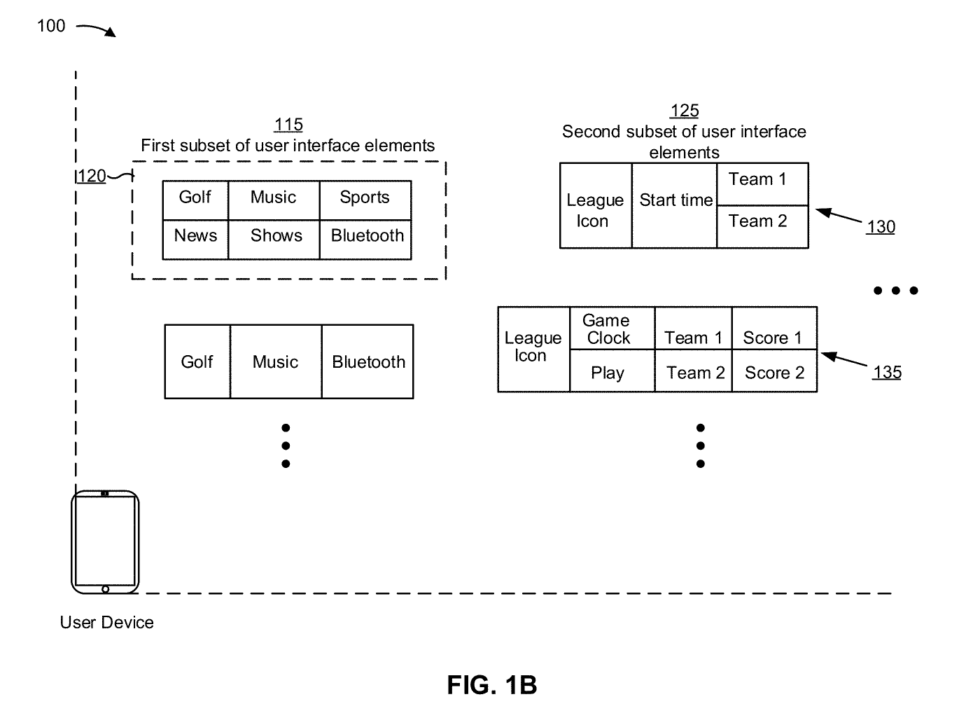

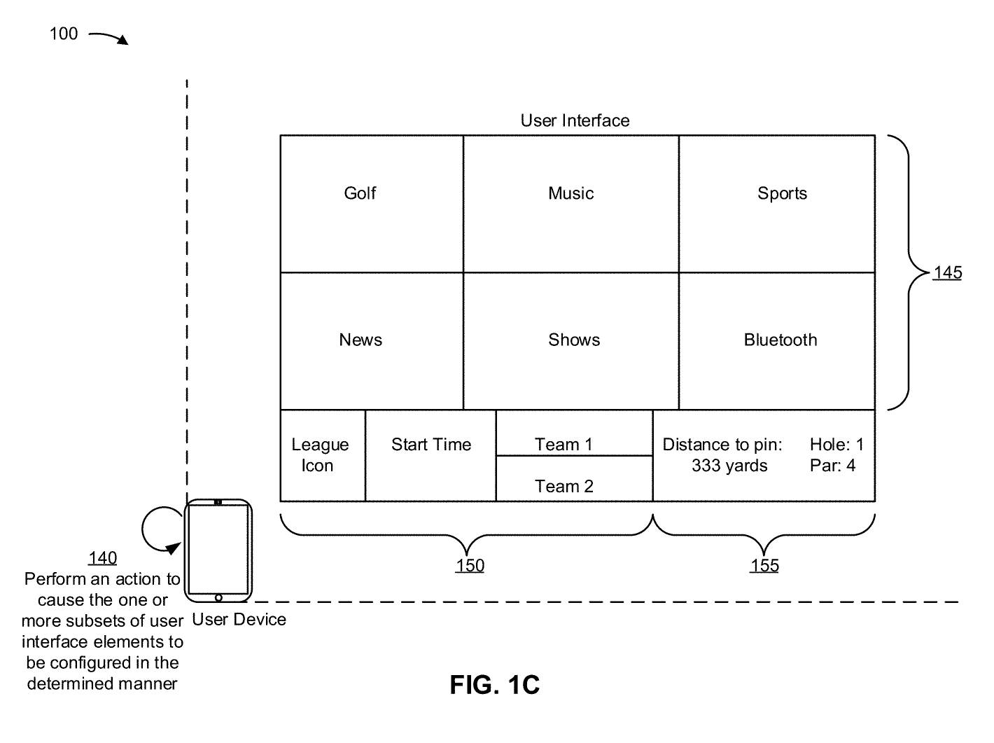

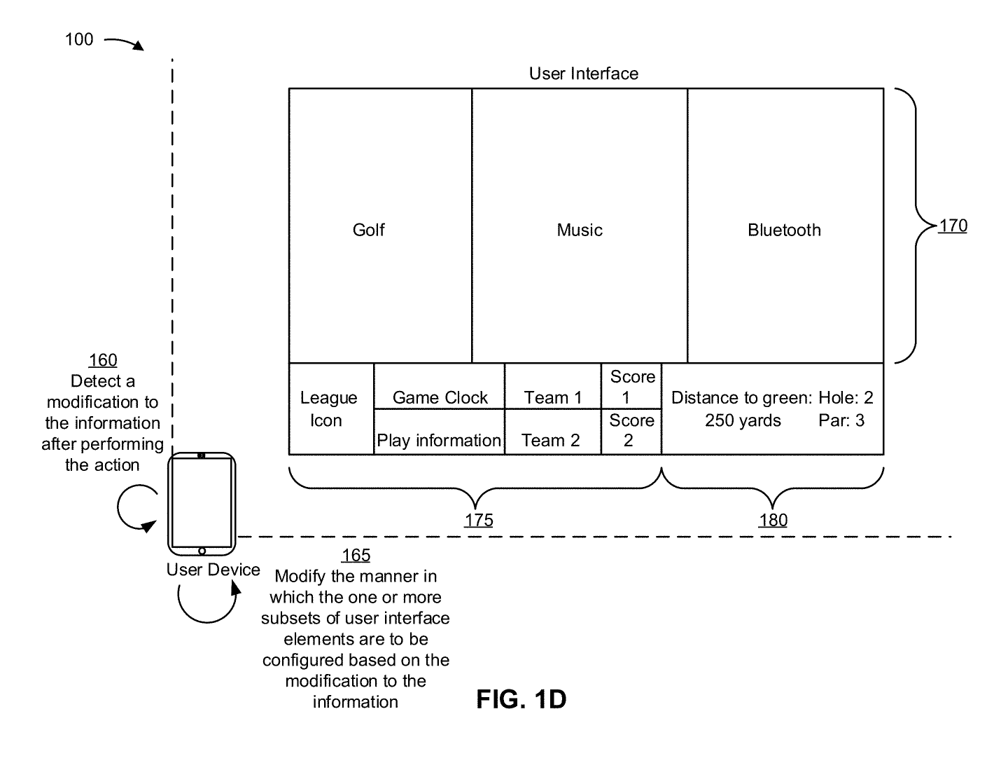

FIGS. 1A-1D are diagrams of an overview of an example implementation 100 described herein. As shown in FIG. 1A, implementation 100 can include a server device and a user device associated with a golf cart. Although FIG. 1A shows a single server device and a single user device, in practice, there can be thousands, millions, billions, etc. of server devices and/or client devices.

As shown in FIG. 1A, and by reference numbers 105-1 and 105-2, the user device can receive information associated with dynamically configuring a set of user interface elements associated with a user interface. For example, and as shown by reference number 105-1, the user device can receive the information from the server device. Additionally, or alternatively, and as another example shown by reference number 105-2, the user device can receive the information from a user of the user device (e.g., via input from the user). In some implementations, the user device can determine the information (e.g., can determine global positioning system (GPS) information, a day of the week or week of the month, by processing information from the server device and/or the user, etc.).

The information that the user device receives can relate to, for example, a user account associated with a user of the user device, information based on a GPS location of the user device, advertisements to be provided for display via a user interface of the user device, events (e.g., news events, sporting events, etc.), a service level associated with an account of a user of the user device, a set of services to be provided via the user device, and/or the like. When receiving the information, the user device can receive thousands, millions, billions, etc. of data elements. In this way, the user device can receive a data set that cannot be processed manually or objectively by a human actor. In addition, the user device can receive the information in real-time, or near real-time.

As shown by reference number 110, the user device can process the information to determine a manner in which to configure one or more subsets of user interface elements, of the set of user interface elements. For example, the user device can process the information to identify a service level associated with an account of the user, to identify trends among data of users of other user devices (e.g., using machine learning or artificial intelligence), a priority of the information relative to other information (e.g., information related to a live event, or a breaking news event, can be prioritized higher than other information related to other events), to determine whether the information satisfies a threshold, and/or the like. In some implementation, the server device, rather than the user device, can process the information and can provide information identifying a result of the processing to the user device to permit the user device to determine a manner in which to configure one or more subsets of user interface elements.

The user device can determine a manner in which to configure one or more subsets of user interface elements based on processing the information. For example, the user device can determine to configure a first subset of user interface elements in a first manner based on information satisfying a threshold. Additionally, or alternatively, and as another example, the user device can determine to configure a second subset of user interface elements in a second manner based on the information being associated with a threshold priority. Additionally, or alternatively, and as another example, the user device can determine to configure a third subset of user interface elements in a third manner based on a trend identified in the data.

As shown in FIG. 1B, and by reference number 115, the user device can determine a manner in which to configure a first subset of user interface elements (e.g., a subset of user interface elements associated with a homepage of an application). For example, the user device can receive information identifying an account of a user of the user device, a service level for which the user has provided payment, a set of services to be provided via the user device, and/or the like, and can determine a manner in which to configure the first subset of user interface elements based on the information. Continuing with the previous example, assume that the user paid for a first set of services that includes access to various types of content, such as golf-related content, music, sports-related content, news-related content, shows, use of Bluetooth, and/or the like. In this case, and as shown by reference number 120, the user device can determine to configure the first subset of user interface elements such that the first subset of user interface elements includes, buttons, menu items, and/or the like related to the previously described content.

As shown by reference number 125, the user device can determine a manner in which to configure a second subset of user interface elements (e.g., a subset of user interface elements related to a ticker menu that displays sports-related information). For example, the user device can determine a manner in which to configure the second subset of user interface elements based on information indicating whether a particular sporting event is upcoming, whether a particular sporting event is in progress, and/or the like. Continuing with the previous example, and as shown by reference number 130, the user device can determine to configure the second subset of user interface elements in a first manner when a sporting event is upcoming. Continuing still with the previous example, and as shown by reference number 135, the user device can determine to configure the second subset of user interface elements in a second manner when a sporting event is in progress. The user device can configure the previously described subsets of user interface elements in different manners, configure different subsets of user interface elements in the same or different manners, based on different information, and/or the like, as described elsewhere herein.

As shown in FIG. 1C, and by reference number 140, the user device can perform an action to cause the one or more subsets of user interface elements to be configured in the determined manner. For example, the user device can provide the one or more subsets of user interface elements for display, display the one or more subsets of user interface elements via a display of the user device, generate a set of instructions to cause another device to display, or provide for display, the one or more subsets of user interface elements, and/or the like. As shown by reference number 145, the user device can cause the first subset of user interface elements to be configured in the determined manner. In addition, and as shown by reference number 150, the user device can cause the second subset of user interface elements to be configured in the determined manner. Further, and as shown by reference number 155, the user device can cause a third set of user interface elements, not described above, to be configured in the determined manner.

As shown in FIG. 1D, and by reference number 160, the user device can detect a modification to the information after performing the action. For example, the user device can detect (e.g., using additional received information) that a user of the user device has downgraded a service level, that a previously upcoming sporting event is now in progress, that the user device has changed location, and/or the like. The user device can re-process additional information, in a manner similar to that described above, to detect the modification and/or to re-determine a manner in which to configure the one or more subsets of user interface elements based on the additional information.

As shown by reference number 165, the user device can modify the manner in which the one or more subsets of user interface elements are to be configured based on the modification to the information. For example, the user device can cause the one or more subsets of user interface elements to be displayed in a different manner based on detecting the modification. For example, and as shown by reference number 170, the user device can cause the first subset of user interface elements to be configured in a different manner based on detecting that the user of the user device has downgraded a service level (e.g., such that the first subset of user interface elements includes fewer buttons, or menu options, to reflect a more limited access to content associated with the downgraded service level).

As another example, and as shown by reference number 175, the user device can cause the second subset of user interface elements to be configured in a different manner based on detecting that a sporting event is in progress, rather than upcoming (e.g., such that information related to game play of the sporting event is provided for display via the second subset of user interface elements). As another example, and as shown by reference number 180, the user device can cause the third subset of user interface elements to be configured in a different manner (e.g., based on a change in location of the user device).

In this way, the device dynamically configures the various user interface elements in real-time, thereby improving use of a user interface. This conserves processing resources that would otherwise be consumed providing un-needed user interface elements for display, via selection of user interface elements that are not needed for a particular use (e.g., via accidental selection by a user of the user interface), and/or the like. In addition, this enhances a user experience of a user of the user interface via dynamic configuration of various sets of user interface elements for particular uses, particular needs, and/or the like.

As indicated above, FIGS. 1A-1D are provided merely as an example. Other examples are possible and can differ from what was described with regard to FIGS. 1A-1D. For example, the user device can configure different subsets of user interface elements than what was described with regard to FIGS. 1A-1D, can configure subsets of user interface elements in a different manner than what was described with regard to FIGS. 1A-1D, can use different information than what was described with regard to FIGS. 1A-1D, and/or the like. In addition, although FIGS. 1A-1D describe a user device as performing the implementations, the implementations apply equally to a server device. Further, although some implementations were described with respect to a golf cart, the implementations apply equally to other contexts, such as a vehicle navigation system, or contexts other than transportation.

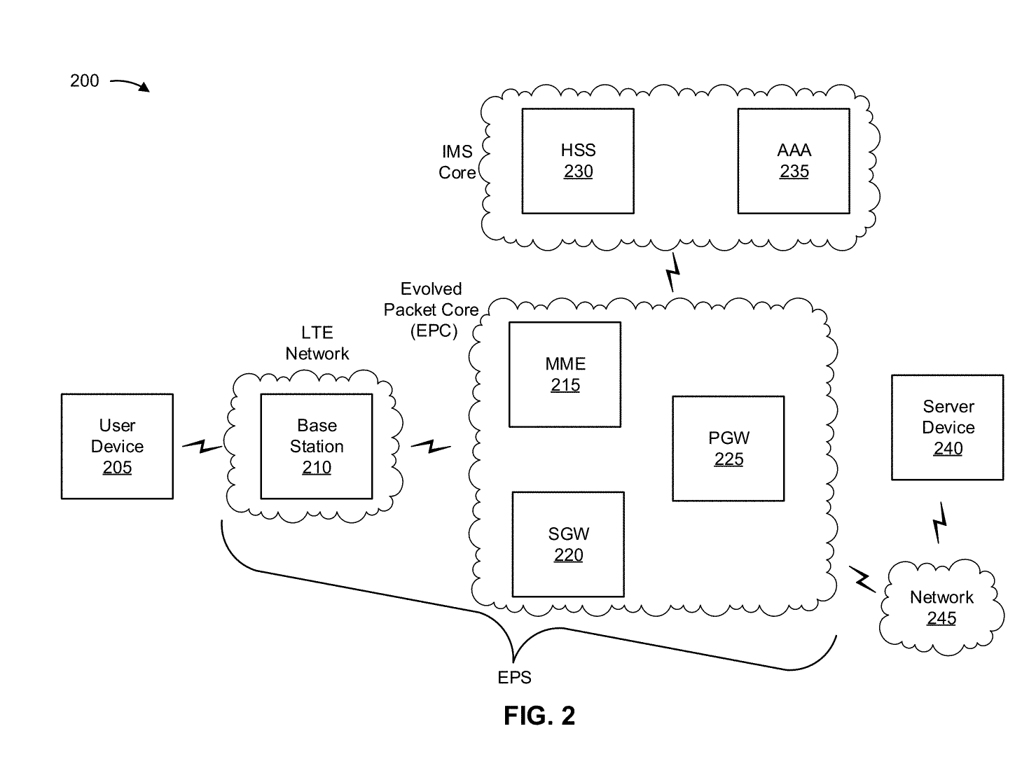

FIG. 2 is a diagram of an example environment 200 in which systems and/or methods, described herein, can be implemented. As shown in FIG. 2, environment 200 can include a user device 205; a base station 210; a mobility management entity device (MME) 215; a serving gateway (SGW) 220; a packet data network gateway (PGW) 225; a home subscriber server (HSS) 230; an authentication, authorization, and accounting server (AAA) 235, a server device 240; and a network 245. Devices of environment 200 can interconnect via wired connections, wireless connections, or a combination of wired and wireless connections.

Some implementations are described herein as being performed within a long term evolution (LTE) network for explanatory purposes. Some implementations can be performed within a network that is not an LTE network, such as a third generation (3G) network, a fourth generation (4G) network, a fifth generation (5G) network, etc.

Environment 200 includes an evolved packet system (EPS) that includes an LTE network and/or an evolved packet core (EPC) that operate based on a third generation partnership project (3GPP) wireless communication standard. The LTE network can include a radio access network (RAN) that includes one or more base stations 210 that take the form of evolved Node Bs (eNBs) via which user device 205 communicates with the EPC. The EPC includes MME 215, SGW 220, and/or PGW 225 that enable user device 205 to communicate with network 245 and/or an Internet protocol (IP) multimedia subsystem (IMS) core. The IMS core can include HSS 230 and/or AAA 235, and can manage device registration and authentication, session initiation, etc., associated with user device 205. HSS 230 and/or AAA 235 can reside in the EPC and/or the IMS core.

User device 205 includes one or more devices capable of receiving, generating, storing, processing, and/or providing, information associated with configuration of user interface elements. For example, user device 205 can include a mobile phone (e.g., a smart phone, a radiotelephone, etc.), a laptop computer, a tablet computer, a handheld computer, a gaming device, a wearable communication device (e.g., a smart wristwatch, a pair of smart eyeglasses, etc.), or a similar type of device. In some implementations, user device 205 can receive input from a user of user device 205 and/or from server device 240 that indicates a manner in which user interface elements of a user interface associated with user device 205 are to be configured, as described elsewhere herein. Additionally, or alternatively, user device 205 can configure user interface elements of a user interface based on the information, as described elsewhere herein. In practice there can be hundreds, thousands, millions, etc. of user devices 205.

Base station 210 includes one or more devices capable of transferring traffic, such as audio, video, text, and/or other traffic, destined for and/or received from user device 205. In some implementations, base station 210 can include an eNB associated with the LTE network that receives traffic from and/or sends traffic to network 245 via SGW 220 and/or PGW 225. Additionally, or alternatively, one or more base stations 210 can be associated with a RAN that is not associated with the LTE network. Base station 210 can send traffic to and/or receive traffic from user device 205 via an air interface. In some implementations, base station 210 can include a small cell base station, such as a base station of a microcell, a picocell, and/or a femtocell. Although FIG. 2 shows a single base station 210, in practice, there can be hundreds, thousands, millions, etc. of base stations 210 providing information to and/or receiving information from user device 205, as described elsewhere herein.

MME 215 includes one or more devices, such as one or more server devices, capable of managing authentication, activation, deactivation, and/or mobility functions associated with user device 205. In some implementations, MME 215 can perform operations relating to authentication of user device 205. Additionally, or alternatively, MME 215 can facilitate the selection of a particular SGW 220 and/or a particular PGW 225 to serve traffic to and/or from user device 205. MME 215 can perform operations associated with handing off user device 205 from a first base station 210 to a second base station 210 when user device 205 is transitioning from a first cell associated with the first base station 210 to a second cell associated with the second base station 210. Additionally, or alternatively, MME 215 can select another MME (not pictured), to which user device 205 should be handed off (e.g., when user device 205 moves out of range of MME 215).

SGW 220 includes one or more devices capable of routing packets. For example, SGW 220 can include one or more data processing and/or traffic transfer devices, such as a gateway, a router, a modem, a switch, a firewall, a network interface card (NIC), a hub, a bridge, a server device, an optical add/drop multiplexer (OADM), or any other type of device that processes and/or transfers traffic. In some implementations, SGW 220 can aggregate traffic received from one or more base stations 210 associated with the LTE network, and can send the aggregated traffic to network 245 (e.g., via PGW 225) and/or other network devices associated with the EPC and/or the IMS core. SGW 220 can also receive traffic from network 245 and/or other network devices, and can send the received traffic to user device 205 via base station 210. Additionally, or alternatively, SGW 220 can perform operations associated with handing off user device 205 to and/or from an LTE network.

PGW 225 can include one or more devices capable of providing connectivity for user device 205 to external packet data networks (e.g., other than the depicted EPC and/or LTE network). For example, PGW 225 can include one or more data processing and/or traffic transfer devices, such as a gateway, a router, a modem, a switch, a firewall, a NIC, a hub, a bridge, a server device, an OADM, or any other type of device that processes and/or transfers traffic. In some implementations, PGW 225 can aggregate traffic received from one or more SGWs 220, and can send the aggregated traffic to network 245. Additionally, or alternatively, PGW 225 can receive traffic from network 245, and can send the traffic to user device 205 via SGW 220 and base station 210. PGW 225 can record data usage information (e.g., byte usage), and can provide the data usage information to AAA 235.

HSS 230 includes one or more devices, such as one or more server devices, capable of managing (e.g., receiving, generating, storing, processing, and/or providing) information associated with user device 205. For example, HSS 230 can manage subscription information associated with user device 205, such as information that identifies a subscriber profile of a user associated with user device 205, information that identifies services and/or applications that are accessible to user device 205, location information associated with user device 205, a network identifier (e.g., a network address) that identifies user device 205, information that identifies a treatment of user device 205 (e.g., quality of service information, a quantity of minutes allowed per time period, a quantity of data consumption allowed per time period, etc.), and/or similar information. HSS 230 can provide this information to one or more other devices of environment 200 to support the operations performed by those devices.

AAA 235 includes one or more devices, such as one or more server devices, that perform authentication, authorization, and/or accounting operations for communication sessions associated with user device 205. For example, AAA 235 can perform authentication operations for user device 205 and/or a user of user device 205 (e.g., using one or more credentials), can control access, by user device 205, to a service and/or an application (e.g., based on one or more restrictions, such as time-of-day restrictions, location restrictions, single or multiple access restrictions, read/write restrictions, etc.), can track resources consumed by user device 205 (e.g., a quantity of voice minutes consumed, a quantity of data consumed, etc.), and/or can perform similar operations.

Server device 240 includes one or more devices capable of receiving, generating, storing, processing, and/or providing information associated with dynamically configuring user interface elements. For example, server device 240 can include a server (e.g., in a data center or a cloud computing environment), a data center (e.g., a multi-server micro data center), a workstation computer, a virtual machine (VM) provided in a cloud computing environment, or a similar type of device. In some implementations, server device 240 can provide information to user device 205 to permit user device 205 to determine a manner in which to dynamically configure user interface elements of a user interface, as described elsewhere herein. Additionally, or alternatively, server device 240 can determine a manner in which to configure user interface elements associated with a user interface and can provide a set of instructions to user device 205 to configure the user interface elements in the determined manner, as described elsewhere herein. In practice there can be hundreds, thousands, millions, etc. of server devices 240.

Network 245 includes one or more wired and/or wireless networks. For example, network 245 can include a cellular network (e.g., a long-term evolution (LTE) network, a code division multiple access (CDMA) network, a 3G network, a 4G network, a 5G network, or another type of cellular network), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, a cloud computing network, a content delivery network, and/or the like, and/or a combination of these or other types of networks.

The number and arrangement of devices and networks shown in FIG. 2 are provided as an example. In practice, there can be additional devices and/or networks, fewer devices and/or networks, different devices and/or networks, or differently arranged devices and/or networks than those shown in FIG. 2. Furthermore, two or more devices shown in FIG. 2 can be implemented within a single device, or a single device shown in FIG. 2 can be implemented as multiple, distributed devices. Additionally, or alternatively, a set of devices (e.g., one or more devices) of environment 200 can perform one or more functions described as being performed by another set of devices of environment 200.

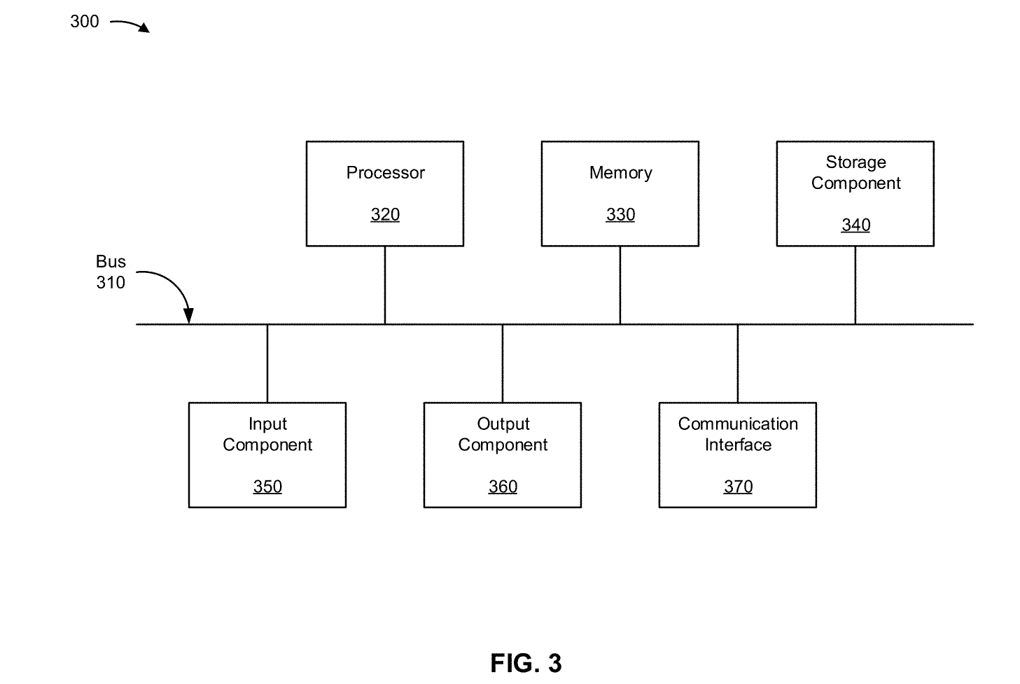

FIG. 3 is a diagram of example components of a device 300. Device 300 can correspond to user device 205, base station 210, MME 215, SGW 220, PGW 225, HSS 230, AAA 235, and/or server device 240. In some implementations, user device 205, base station 210, MME 215, SGW 220, PGW 225, HSS 230, AAA 235, and/or server device 240 can include one or more devices 300 and/or one or more components of device 300. As shown in FIG. 3, device 300 can include a bus 310, a processor 320, a memory 330, a storage component 340, an input component 350, an output component 360, and a communication interface 370.

Bus 310 includes a component that permits communication among the components of device 300. Processor 320 is implemented in hardware, firmware, or a combination of hardware and software. Processor 320 includes a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 320 includes one or more processors capable of being programmed to perform a function. Memory 330 includes a random access memory (RAM), a read only memory (ROM), and/or another type of dynamic or static storage device (e.g., a flash memory, a magnetic memory, and/or an optical memory) that stores information and/or instructions for use by processor 320.

Storage component 340 stores information and/or software related to the operations and use of device 300. For example, storage component 340 can include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 350 includes a component that permits device 300 to receive information, such as via user input (e.g., a touch screen display, a keyboard, a keypad, a mouse, a button, a switch, and/or a microphone). Additionally, or alternatively, input component 350 can include a sensor for sensing information (e.g., a global positioning system (GPS) component, an accelerometer, a gyroscope, and/or an actuator). Output component 360 includes a component that provides output information from device 300 (e.g., a display, a speaker, and/or one or more light-emitting diodes (LEDs)).

Communication interface 370 includes a transceiver-like component (e.g., a transceiver and/or a separate receiver and transmitter) that enables device 300 to communicate with other devices, such as via a wired connection, a wireless connection, or a combination of wired and wireless connections. Communication interface 370 can permit device 300 to receive information from another device and/or provide information to another device. For example, communication interface 370 can include an Ethernet interface, an optical interface, a coaxial interface, an infrared interface, a radio frequency (RF) interface, a universal serial bus (USB) interface, a Wi-Fi interface, a cellular network interface, or the like.

Device 300 can perform one or more processes described herein. Device 300 can perform these processes based on processor 320 executing software instructions stored by a non-transitory computer-readable medium, such as memory 330 and/or storage component 340. A computer-readable medium is defined herein as a non-transitory memory device. A memory device includes memory space within a single physical storage device or memory space spread across multiple physical storage devices.

Software instructions can be read into memory 330 and/or storage component 340 from another computer-readable medium or from another device via communication interface 370. When executed, software instructions stored in memory 330 and/or storage component 340 can cause processor 320 to perform one or more processes described herein. Additionally, or alternatively, hardwired circuitry can be used in place of or in combination with software instructions to perform one or more processes described herein. Thus, implementations described herein are not limited to any specific combination of hardware circuitry and software.

The number and arrangement of components shown in FIG. 3 are provided as an example. In practice, device 300 can include additional components, fewer components, different components, or differently arranged components than those shown in FIG. 3. Additionally, or alternatively, a set of components (e.g., one or more components) of device 300 can perform one or more functions described as being performed by another set of components of device 300.

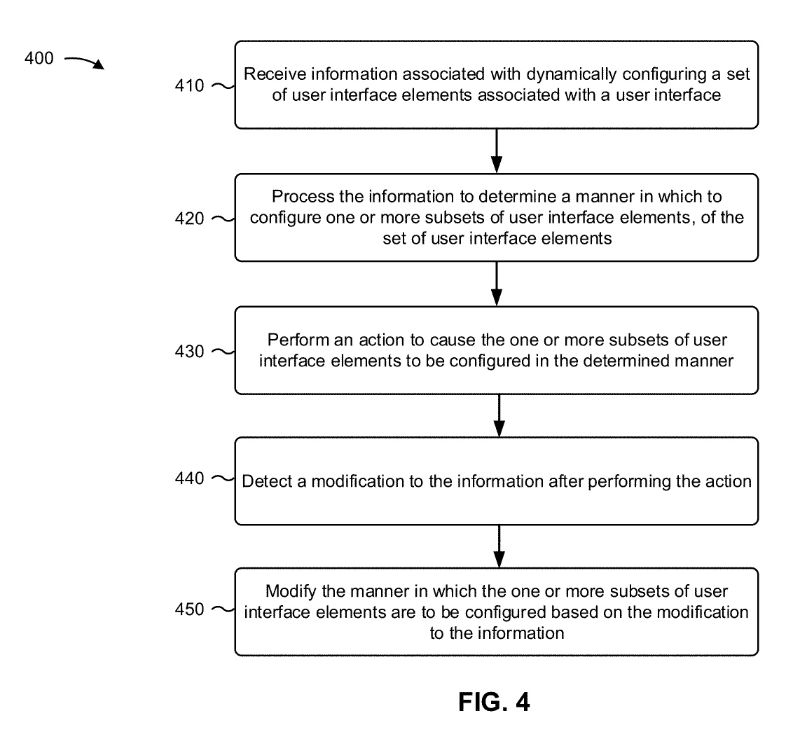

FIG. 4 is a flow chart of an example process 400 for dynamic configuration of user interface elements. In some implementations, one or more process blocks of FIG. 4 can be performed by user device 205. In some implementations, one or more process blocks of FIG. 4 can be performed by another device or a group of devices separate from or including user device 205, such as base station 210, MME 215, SGW 220, PGW 225, HSS 230, AAA 235, and/or server device 240.

As shown in FIG. 4, process 400 can include receiving information associated with dynamically configuring a set of user interface elements associated with a user interface (block 410). For example, user device 205 can receive information associated with dynamically configuring a set of user interface elements associated with a user interface. In some implementations, user device 205 can receive the information from server device 240, via base station 210, from a user of user device 205, based on determining the information (e.g., using a GPS, or other sensor, of user device 205), based on requesting the information, periodically, according to a schedule, and/or the like. In some implementations, user device 205 can receive thousands, millions, billions, etc. of data elements when receiving the information. In this way, user device 205 can receive a data set that cannot be processed manually or objectively by a human actor.

In some implementations, user device 205 can receive information after a user of user device 205 logs into an account via user device 205. For example, when user device 205 is associated with a golf cart, a golfer can log into user device 205 to access preferences related to configuring a user interface, to access historical information related to rounds of golf the golfer played at the same or other courses (e.g., strokes of a previous round, clubs used during the previous round and corresponding hits, weather conditions during previous rounds, etc.), services for which the golfer has paid, and/or the like. Continuing with the previous example, user device 205 can request this information from server device 240 using login information that the user input into user device 205.

In some implementations, a user interface can permit a user to interact with electronic devices. For example, a user interface can include a graphical user interface (GUI), a man-machine interface (MMI), a human-computer interface, a web-based user interface, a touchscreen, and/or the like. In some implementations, a user interface element can include one or more elements of a user interface that permit a user of a user interface to control a device and/or to control the user interface, that display information, and/or the like. For example, a user interface element can include a window, an icon, a button, a toggle, a media player, a text box, a label, a radio button, a dropdown menu, a ticker menu, and/or the like.

In some implementations, the information that user device 205 receives can include information related to a user of user device 205 (e.g., account information, a service level, a subscription to content, an access code, services to be provided via user device 205, etc.), a location of user device 205 (e.g., a GPS location, a landmark, a business, a city, etc.), an event (e.g., news event, a sporting event, etc.), an advertisement (e.g., to be displayed via the user interface), content to be displayed via the user interface (e.g., a show, a movie, etc.), rules related to an advertisement and/or content (e.g., age restrictions rules, placement rules, etc.), and/or the like. In some implementations, user device 205 can receive the information from multiple sources (e.g., multiple server device 240 associated with multiple third parties).

In some implementations, particular information can be associated with a type and/or use of a user interface element. For example, when a user interface is a homepage user interface that provides access to various services, user device 205 can receive information identifying services for which a user of user device 205 has paid, a service level associated with an account of a user of user device 205, a subscription associated with a user of user device 205 (e.g., a subscription for content), and/or the like to permit user device 205 to configure user interface elements of the homepage user interface in a manner that permits the user to access particular services.

Additionally, or alternatively, and as another example, when a user interface includes a ticker menu to display information related to events, user device 205 can receive information identifying the events for which information is to be displayed, information indicating whether the events are upcoming, in progress, or complete (e.g., to permit user device 205 to configure user interface elements differently depending on whether the events are upcoming, in progress, or complete), information related to the events (e.g., information related to scores, plays, highlights, etc. when the events are sporting events) to be displayed via a user interface element, and/or the like.

In some implementations, user device 205 can receive information based on a use of a user interface element (e.g., a use related to displaying information, to providing control of a user interface, to permitting navigation through various user interfaces, etc.). For example, when a user interface element is to be used to provide information for display, user device 205 can receive information identifying a manner in which the user interface element is to be configured and information that is to be displayed via the user interface element. In some implementations, user device 205 can determine a type and/or use of a user interface element (e.g., by processing information related to the user interface element and/or the use of the user interface element) and can request the information based on the type and/or use of the user interface element.

In some implementations, user device 205 can determine the information. For example, user device 205 can determine a GPS location of user device 205 using a GPS associated with user device 205 and can determine a business location, a city, and/or the like of user device 205 (e.g., using a data structure, by providing the information identifying the GPS location to server device 240, etc.). Additionally, or alternatively, and as another example, user device 205 can process information received from server device 240 to determine a trend related to information associated with other user devices 205, such as to permit user device 205 to configure a set of user interface elements in a manner that matches the trend. This conserves processing resources that would otherwise be consumed receiving the information and/or can increase an efficiency of receiving the information by reducing or eliminating a need for user device 205 to receive the information. In some implementations, server device 240, rather than user device 205, can determine the information.

In this way, user device 205 can receive information associated with dynamically configuring a set of user interface elements associated with a user interface to permit user device 205 to process the information.

As further shown in FIG. 4, process 400 can include processing the information to determine a manner in which to configure one or more subsets of user interface elements, of the set of user interface elements (block 420). For example, user device 205 can process the information to determine a manner in which to configure one or more subsets of user interface elements, of the set of user interface elements. In some implementations, user device 205 can process thousands, millions, billions, etc. of data elements. In this way, user device 205 can process a data set that cannot be processed manually or objectively by a human actor.

In some implementations, user device 205 can process the information to determine whether the information satisfies a threshold. Additionally, or alternatively, user device 205 can process the information to determine whether the information includes a particular value. Additionally, or alternatively, user device 205 can process the information to determine an amount of information to be displayed by the user interface element (e.g., to determine dimensions of the user interface element, a placement of the user interface element relative to other user interface elements, etc.). Additionally, or alternatively, user device 205 can process the information to identify a pattern in the data or a trend in the data (e.g., using pattern analysis, trend analysis, machine learning, etc.), such as a pattern and/or trend related to information associated with other users and/or user devices 205, historical information associated with a user of user device 205, and/or the like. Additionally, or alternatively, user device 205 can process the information to identify a term and/or phrase included in the information (e.g., using natural language processing, text analysis, etc.). Specific examples of processing information to determine a manner in which to configure a subset of user interface elements are described below.

In some implementations, and as an example related to a homepage user interface, user device 205 can process information to determine user interface elements to be displayed, a configuration of the user interface elements, and/or the like. For example, user device 205 can process the information to determine a set of services for which a user of user device 205 has paid (e.g., by processing account information after a user logs into an account, receiving information that identifies a user selection of a set of services, etc.). Continuing with the previous example, user device 205 can determine a first set of user interface elements to be displayed when the user has paid for a first set of services, a second set of user interface elements when the user has paid for a second set of services, and/so forth.

In some implementations, user device 205 can determine that particular user interface elements are not to be displayed. For example, user device 205 can determine that particular user interface elements are not associated with a set of services for which the user has paid. Continuing with the previous example, user device 205 can determine that the particular user interface elements are not to be displayed based on being associated with services for which the user has not paid. This conserves space of the user interface, and improves a usability of the user interface (e.g., by reducing or eliminating un-needed user interface elements from a configuration of user interface elements). In addition, this conserves processing resources that would otherwise be consumed providing the user interface elements for display via a user interface.

In some implementations, and as an example related to a user interface used to navigate through various screens, user interfaces, and/or the like of an application, user device 205 can process the information to determine a manner in which the navigation-related user interface elements are to be configured in a manner similar to that described above with respect to the homepage user interface. For example, user device 205 can determine the manner in which the user interface elements are to be configured based on a set of services for which a user of user device 205 has paid.

In some implementations, and as an example related to a sports ticker user interface element, user device 205 can process the information to determine a manner in which the sports ticker user interface element is to be displayed. For example, user device 205 can process the information to determine a set of sports that are in season and can determine to configure the sports ticker user interface element such that the sports ticker user interface element displays information for the set of sports that are in season. Additionally, or alternatively, user device 205 can receive information identifying preferences of a user of user device 205 (e.g., via input of the user) related to sports, such as sports the user likes to watch, teams the user follows, fantasy sports the user plays (e.g., information from a fantasy sports account and/or league of the user), and/or the like. In this case, user device 205 can determine a manner in which to configure a sports ticker user interface to display sports-related information based on the user's preferences.

In some implementations, user device 205 can process the information to determine whether a particular sporting event is upcoming, in progress, complete, and/or the like. Continuing with the previous example, user device 205 can determine to dynamically configure a sports ticker user interface element for a particular sporting event in a first manner when the sporting event is upcoming, in a second manner when the sporting event is in progress, or in a third manner when the sporting event is complete. In some implementations, user device 205 can determine to configure a sports ticker user interface element in a particular manner for a threshold amount of time after a sporting event is complete or prior to the sporting event, until a particular day and/or time after the sporting event is complete, and/or the like.

In some implementations, user device 205 can determine an amount of time for which a sports ticker user interface element is to display information related to a sporting event, a manner in which the user interface element is to display the information (e.g., determine whether to display the information statically, to scroll through the information, etc.), and/or the like. For example, user device 205 can determine that the information to be displayed contains a threshold quantity of characters, can be displayed within the bounds or dimensions of the sports ticker user interface element, such as an area of the user interface element, a length of the user interface element, a width of the user interface element, a quantity of pixels related to the foregoing, etc. (e.g., using a threshold size font), and/or the like. Continuing with the previous example, user device 205 can determine that information related to the sporting event is to be displayed statically using the sports ticker user interface element when the information can be displayed within the dimensions or bounds of the sports ticker user interface element, that the information to be displayed includes a threshold quantity of characters, and/or the like. Conversely, and continuing still with the previous example, user device 205 can determine that the sports ticker user interface element is to display information related to a sporting event in a scrolling manner (e.g., where the sports ticker user interface element scrolls through the information) based on determining that the information cannot be displayed within the dimensions of the sports ticker user interface element that the information to be display includes a threshold quantity of characters, and/or the like.

Additionally, or alternatively, and as another example, user device 205 can determine that the user interface element is to display information related to a sporting event for a threshold amount of time based on the information including a threshold quantity of characters. Continuing with the previous example, user device 205 can determine that the sports ticker user interface element is to display information that includes a first threshold quantity of characters for a first threshold amount of time, information that includes a second threshold quantity of characters for a second threshold amount of time, and so forth. Although the above were described with respect to a sports ticker user interface element and sporting events, the implementations apply equally to other types of events, information, and/or the like, such as news events, posts from a social media site, or comments on content.

In some implementations, and as a specific example related to a golf ticker user interface element, user device 205 can process the information to determine a manner in which the golf ticker user interface element is to be displayed (e.g., a ticker that displays information related to user device 205 that is located at a golf course, as determined using, for example, GPS information). For example, user device 205 can process information related to a location of user device 205 to determine a hole at which user device 205 is located, a layout of the hole, a par of the hole, a distance to a green of the hole from user device 205, a distance to a pin of the hole from user device 205, and/or the like. In some implementations, and continuing with the previous example, user device 205 can update, in real-time or near real-time, information displayed by the golf ticker user interface element that identifies a location of user device 205 relative to a hole, a green, a pin, and/or the like.

Additionally, or alternatively, and as another example, user device 205 can determine the information to be displayed by the golf ticker user interface element. For example, user device 205 can process information related to a location of user device 205 to determine whether user device 205 is a threshold distance from a green and/or a pin associated with a hole on a golf course. Continuing with the previous example, when user device 205 determines that user device 205 is a first threshold distance from the green and/or pin, user device 205 can determine that the golf ticker user interface element is to display information identifying a distance to the green from a location of user device 205. Conversely, and continuing still with the previous example, when user device 205 determines that user device is a second threshold distance from the green and/or pin, user device 205 can determine that the golf ticker user interface is to display information identifying a distance to the pin from the location of user device 205.

In some implementations, and as another example, user device 205 can determine whether a golf ticker user interface element is to display information based on men's pars or women's pars. In some implementations, user device 205 can dynamically determine whether to configure the golf ticker user interface element to display men's pars or women's pars based on information identifying a tee off location of a user of user device 205, a preference of user device 205, and/or the like.

In some implementations, and as other examples, user device 205 can configure a golf ticker user interface element to display other golf-related information (e.g., based on information identifying preferences of a user of user device 205), such as club recommendations for a particular golf hole, a layout of a golf hole, a wind speed and/or direction at a golf hole, historical performance of other golfers on the same hole, and/or the like. In some implementations, user device 205 can dynamically adjust a size of the golf ticker user interface element. For example, when user device 205 determines that user device 205 is at a particular location (e.g., a tee box) or has stopped moving, user device 205 can increase a size of the golf ticker user interface element to cause information related to a golf hole to be displayed larger relative to other information. In some implementations, user device 205 can dynamically configure a size of other user interface elements in a similar manner (e.g., user device 205 can increase a size of a sports ticker user interface element when a particular team scores a point or when the sports ticker user interface element is displaying information related to a particular team).

Although the above were described with respect to a golf ticker user interface element and golf-related information, the implementations apply equally to other location-based contexts and/or other location-based information, such as hiking (e.g., based on information related to a point of interest), baseball (e.g., information related to distances of hits), an amusement park (e.g., information related to locations of particular attractions), businesses (e.g., information related to locations of goods within a store), weather (e.g., information related to inclement weather), and/or the like.

In some implementations, and as another example, user device 205 can determine a manner in which to configure a set of user interface elements related to displaying content (e.g., shows, movies, sporting events, embedded content, cached content, advertisements, etc.). In some implementations, user device 205 can receive information identifying a schedule of content to be provided for display and can process the information to determine a type of content to be provided for display (e.g., pre-recorded content, live content, a show, a movie, a sporting event, etc.), a source of the content to be provided for display (e.g., an advertiser, a sponsored source, a free source, etc.), and/or the like. Additionally, or alternatively, user device 205 can receive other information related to user preferences related to content, rules related to displaying content (e.g., geographic location rules, context rules, such as placement of content next to particular types of advertisements, rules related to preferences for positioning of content on a user interface, etc.).

In some implementations, user device 205 can process the information related to the content and the other information to determine a manner in which to configure user interface elements related to displaying content. For example, user device 205 can determine that user interface elements related to live content are to be displayed preferentially relative to non-live content (e.g., in a center of a user interface, a top left corner of a user interface, etc.). Additionally, or alternatively, and as another example, user device 205 can determine that content from particular sources, or that matches a user preference, is to be displayed preferentially relative to other content, is not to be displayed next to particular types of advertisements (e.g., advertisements that include particular content, are from particular sources, etc.), and/or the like.

In some implementations, user device 205 can determine to display particular information in association with the content (e.g., superimposed on user interface elements used to display the content). For example, user device 205 can determine to display text, such as “Live” on live content, “Sponsored” on sponsored content, and/or the like. In some implementations, user device 205 can provide the particular information for display via a user interface.

In some implementations, and as another example, user device 205 can determine a manner in which to configure user interface elements related to displaying advertisements. In some implementations, user device 205 can determine a manner in which to configure user interface elements related to displaying advertisements based on a type of advertisement to be displayed (e.g., a video advertisement, a display advertisement, a sponsored advertisement, etc.). In some implementations, and as an example related to video advertisements, user device 205 can determine to configure user interface elements to display video advertisements in association with video content. Additionally, or alternatively, and as another example, user device 205 can determine to configure user interface elements to display non-video advertisements (e.g., display advertisements) in association with icons, pictures, and/or other non-video content. Additionally, or alternatively, and as another example, user device 205 can determine to configure user interface elements to display advertisements in a manner paid for by an advertiser (e.g., sponsored advertisements).

In some implementations, user device 205 can determine to configure user interface elements to display advertisements based on a user action. For example, user device 205 can determine to configure user interface elements to display video advertisements when a user of user device 205 selects video content. Additionally, or alternatively, and as another example, user device 205 can determine to configure user interface elements to display non-video advertisements when a user of user device 205 is scrolling through icons, tiles, and/or the like associated with content provided via user device 205.

In some implementations, user device 205 can determine to configure a set of user interfaces based on other content being provided for display via a user interface of user device 205. For example, rules and/or preferences can prevent particular content from being displayed next to, or a threshold distance from, particular advertisements. In this case, user device 205 can process information identifying the set of rules and can determine a manner in which to configure user interface elements to display advertisements based on the set of rules, such that the configuration satisfies the set of rules.

In this way, user device 205 can process the information to determine a manner in which to configure one or more subsets of user interface elements, of the set of user interface elements, to permit user device 205 to perform an action.

As further shown in FIG. 4, process 400 can include performing an action to cause the one or more subsets of user interface elements to be configured in the determined manner (block 430). For example, user device 205 can perform an action to cause the one or more subsets of user interface elements to be configured in the determined manner. In some implementations, and for example, user device 205 can provide user interface elements for display in association with a user interface provided for display by user device 205. Additionally, or alternatively, and as another example, user device 205 can display user interface elements (e.g., when user device 205 includes a display). Additionally, or alternatively, user device 205 can generate a set of instructions that indicate the manner in which the user interface elements are to be configured on a user interface. Continuing with the previous example, user device 205 can provide the set of instructions to another device to cause the other device to display, or provide for display, the user interface elements in the determined manner.

In some implementations, user device 205 can obtain or receive content. For example, user device 205 can obtain content to be provided for display via user interface elements. Additionally, or alternatively, user device 205 can obtain or receive information. For example, user device 205 can obtain information related to an event, a user, and/or the like to be provided for display via the user interface elements. In some implementations, user device 205 can obtain or receive the content and/or the information from server device 240.

In this way, user device 205 can perform an action to cause the set of user interface elements to be configured in the determined manner.

As further shown in FIG. 4, process 400 can include detecting a modification to the information after performing the action (block 440). For example, user device 205 can detect a modification to the information after performing the action.

In some implementations, user device 205 can detect a modification to the information based on communicating with server device 240. For example, user device 205 can receive updates to the information from server device 240 periodically, according to a schedule, based on requesting an update, and/or the like. Additionally, or alternatively, user device 205 can detect a modification based on monitoring for the information. For example, user device 205 can monitor information identifying a user of user device 205, a location of user device 205, and/or the like and can detect a modification to the information based on monitoring the information. Additionally, or alternatively, user device 205 can detect a modification based on input from a user of user device 205. For example, user device 205 can receive input from a user of user device 205 that indicates a modification to the information.

In this way, user device 205 can detect a modification to the information after performing the action.

As further shown in FIG. 4, process 400 can include modifying the manner in which the one or more subsets of user interface elements are to be configured based on the modification to the information (block 450). For example, user device 205 can modify the manner in which the one or more subsets of user interface elements are to be configured based on the modification to the information.

In some implementations, user device 205 can modify the manner in which the user interface elements are to be configured by re-determining the manner in which the user interface elements are to be configured (e.g., in a manner similar to that described above). For example, user device 205 can determine to remove user interface elements from a user interface based on the modification to the information. Additionally, or alternatively, and as another example, user device 205 can determine to include additional user interface elements on a user interface based on the modification to the information. Additionally, or alternatively, and as another example user device 205 can determine to modify information displayed by a user interface element. Additionally, or alternatively, and as another example, user device 205 can determine to modify an arrangement of user interface elements on a user interface.

In this way, user device 205 can modify the manner in which the one or more subsets of user interface elements are to be configured based on the modification to the information.

Although FIG. 4 shows example blocks of process 400, in some implementations, process 400 can include additional blocks, fewer blocks, different blocks, or differently arranged blocks than those depicted in FIG. 4. Additionally, or alternatively, two or more of the blocks of process 400 can be performed in parallel.

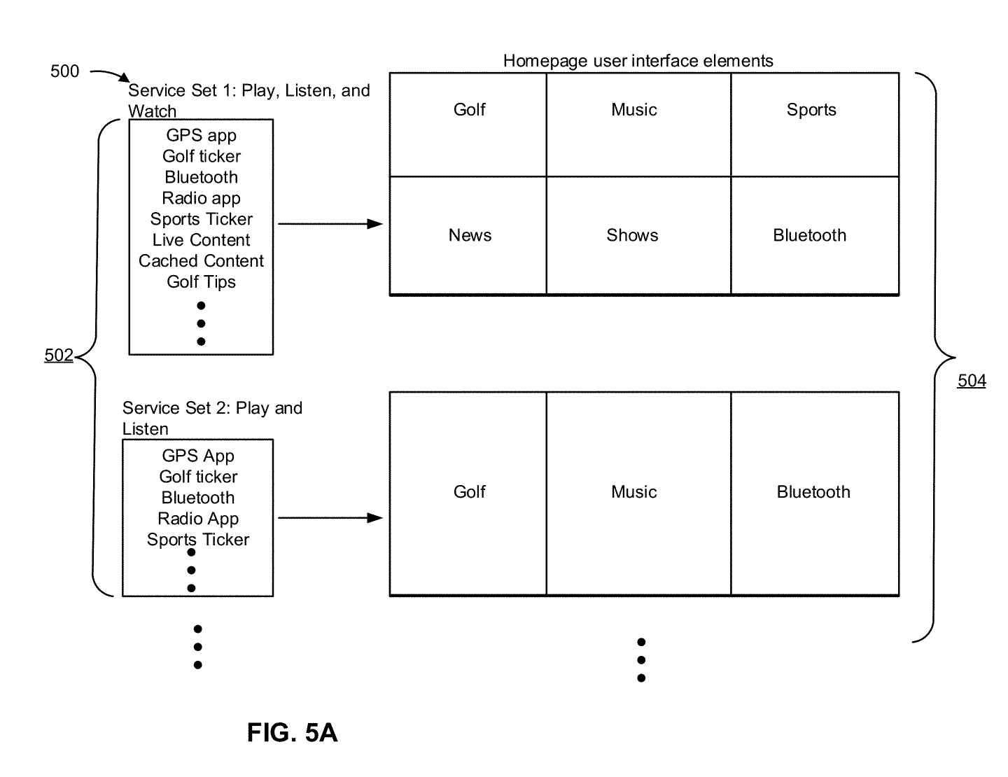

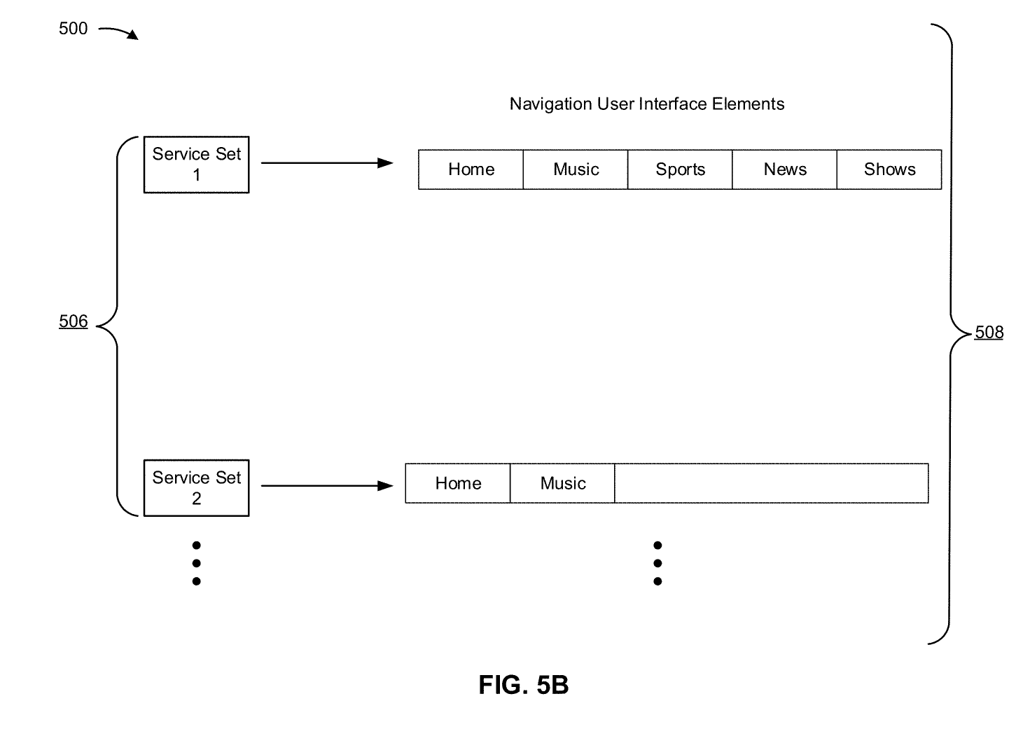

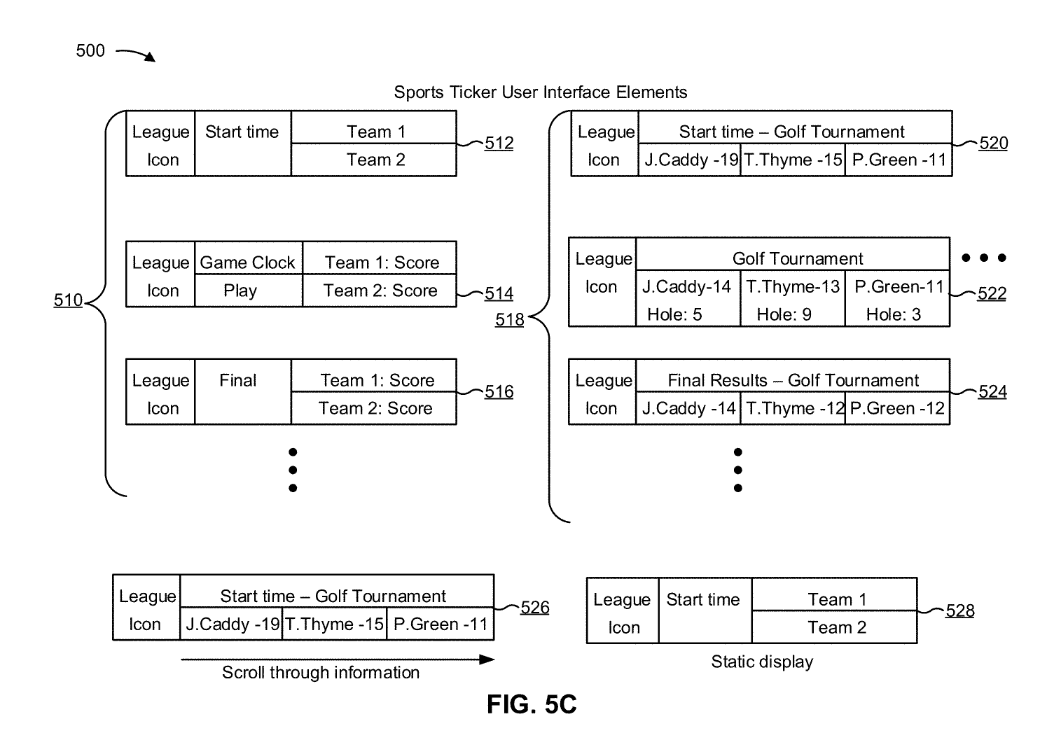

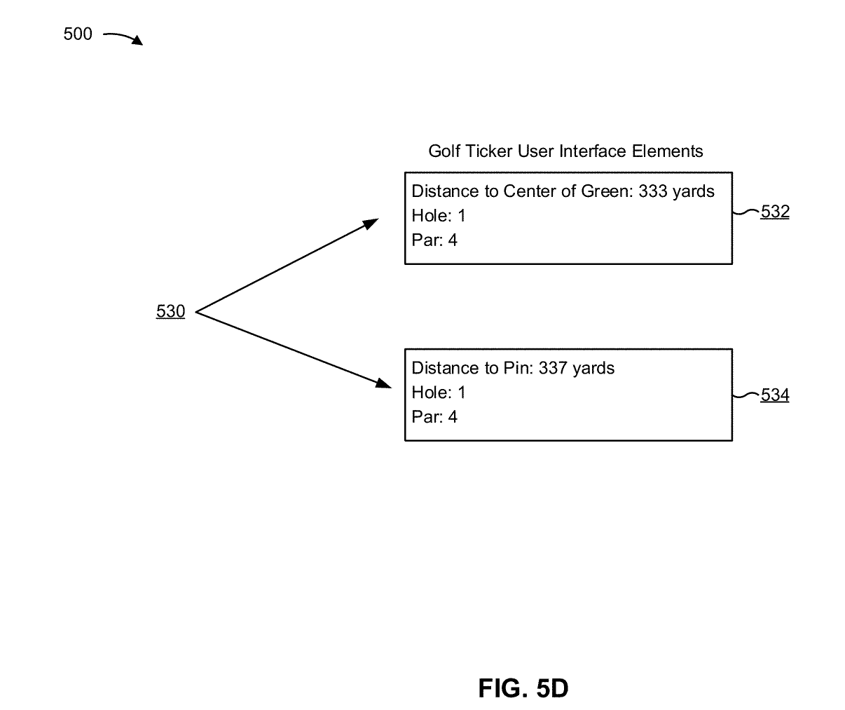

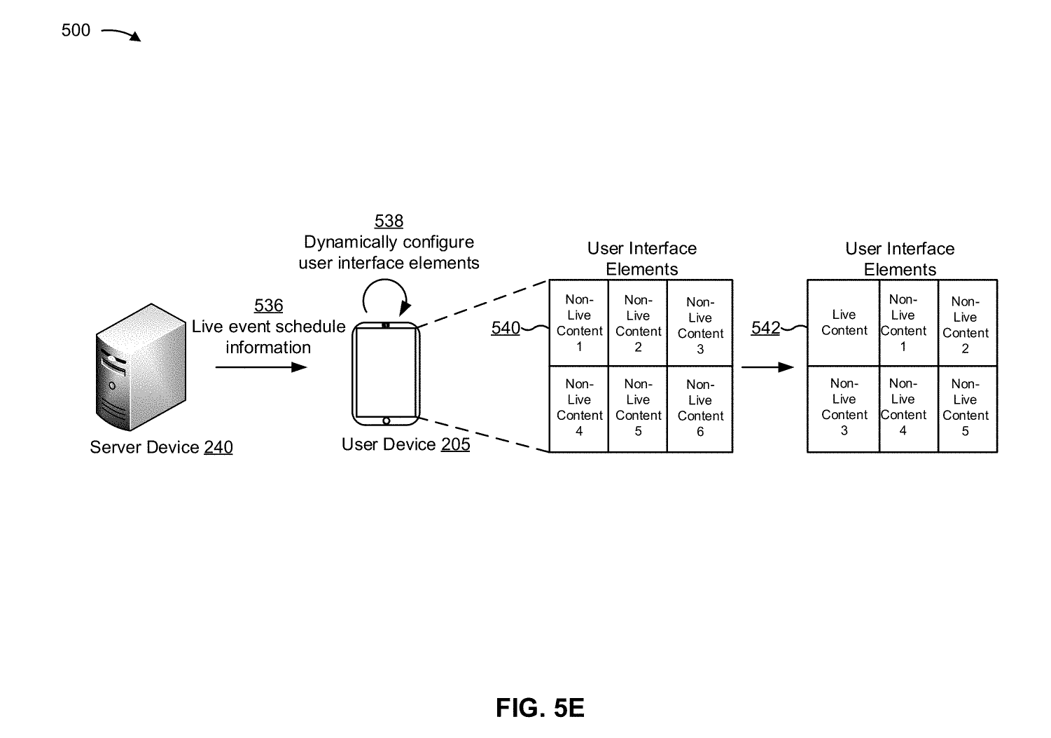

FIGS. 5A-5E are diagrams of an example implementation 500 relating to example process 400 shown in FIG. 4. FIGS. 5A-5E show various examples of manners in which user interface elements can be configured.

As shown in FIG. 5A, and by reference number 502, user device 205 can be associated with various sets of services (e.g., shown as service set 1 and service set 2) to which a user of user device 205 can purchase access. As shown by reference number 504, each of the sets of services can be associated with a particular configuration of user interface elements of a homepage user interface. In some implementations, user device 205 can determine to configure user interface elements of a homepage user interface based on a set of services to which a user of user device 205 has purchased access.

As shown in FIG. 5B, and by reference number 506, the same sets of services described with respect to FIG. 5A can, in addition, be associated with various configurations of user interface elements associated with navigating through user interfaces, screens, and/or the like (e.g., of an application, a webpage, etc.). As shown by reference number 508, each of the sets of services can be associated with particular configuration user interface elements associated with navigating through user interfaces, screens, and/or the like. In some implementations, user device 205 can determine to configure user interface elements related to navigation based on a set of services to which a user of user device 205 has purchased access.

As shown in FIG. 5C, and by reference number 510, user device 205 can determine various configurations for user interface elements associated with a sports ticker user interface element for a team sporting event (e.g., football, soccer, hockey, etc.). In some implementations, user device 205 can determine a configuration based on whether the sporting event is upcoming, in progress, or complete. For example, and as shown by reference number 512, user device 205 can determine a first configuration of user interface elements for a sporting event that is upcoming that includes information identifying a start time for the sporting event, teams participating in the sporting event, a league of the sporting event, and/or the like.

Additionally, or alternatively, and as another example shown by reference number 514, user device 205 can determine a second configuration of user interface elements for a sporting event that is in progress that includes information identifying a game clock for the sporting event, teams participating in the sporting event, a score for each of the teams, a play, possession, and/or the like, a league of the sporting event, and/or the like. Additionally, or alternatively, and as another example shown by reference number 516, user device 205 can determine a third configuration of user interface elements for a sporting event that is complete that includes information identifying that the sporting event is complete, teams that participated in the sporting event, a score for each of the teams, a league of the sporting event, and/or the like.

As shown by reference number 518, user device 205 can determine various configurations for user interface elements associated with a sports ticker user interface element for an individual sporting event (e.g., a golf tournament, a car race, etc.). In some implementations, user device 205 can determine a configuration based on whether the sporting event is upcoming, in progress, or complete, similar to that described above. For example, and as shown by reference numbers 520 through 524, user device 205 can determine a configuration of a sports ticker user interface element that includes information similar to that described above with respect to reference numbers 512 through 516.

As shown by reference number 526, user device 205 can determine to configure a sports ticker user interface element to scroll through information to be displayed by the sports ticker user interface element, in a manner similar to that described elsewhere herein. As shown by reference number 528, user device 205 can determine to configure a sports ticker user interface element to statically display information to be displayed by the sports ticker user interface element, in a manner similar to that described elsewhere herein.

As shown in FIG. 5D, and by reference number 530, user device 205 can determine a configuration for a golf ticker user interface element. For example, user device 205 can determine a configuration for the golf ticker user interface element based on a distance of user device 205 from a green of a golf hole and/or a pin of the golf hole. As shown by reference number 532, user device 205 can determine a first configuration for the golf ticker user interface element based on user device 205 being a threshold distance from a green and/or pin of the golf hole, a user preference of a user of user device 205, and/or the like. For example, the first configuration can include information that identifies a distance to a center of a green associated with a golf hole, the particular hole at which user device 205 is located, a par of the hole, and/or the like.

As shown by reference number 534, user device 205 can determine a second configuration for the golf ticker user interface element based on user device 205 being a threshold distance from a green and/or pin of the golf hole, a user preference of a user of user device 205, and/or the like. For example, the second configuration can include information that identifies a distance to a pin associated with a golf hole, the particular hole at which user device 205 is located, a par of the hole, and/or the like.

As shown in FIG. 5E, and by reference number 536, user device 205 can receive, from server device 240, live event schedule information that identifies a schedule of live events or live content. As shown by reference number 538, user device 205 can dynamically configure user interface elements based on the live event schedule information. For example, user device 205 can configure the user interface elements of a user interface from the configuration shown with respect to reference number 540 to the configuration shown with respect to reference number 542. Continuing with the previous example, assume that user device 205 has configured the user interface elements into the configuration shown by reference number 540 at a first time based on no live content being available. Continuing still with the previous example, user device 205 can configure the user interface elements into the configuration shown by reference number 542 when live content is available (e.g., where user interface elements that provide live content are configured on a user interface preferentially relative to non-live content).

As indicated above, FIGS. 5A-5E are provided merely as an example. Other examples are possible and can differ from what was described with regard to FIGS. 5A-5E. Although FIGS. 5A-5E were described sequentially, the implementations described with regard to FIGS. 5A-5E can occur in parallel, in any order, and/or the like.

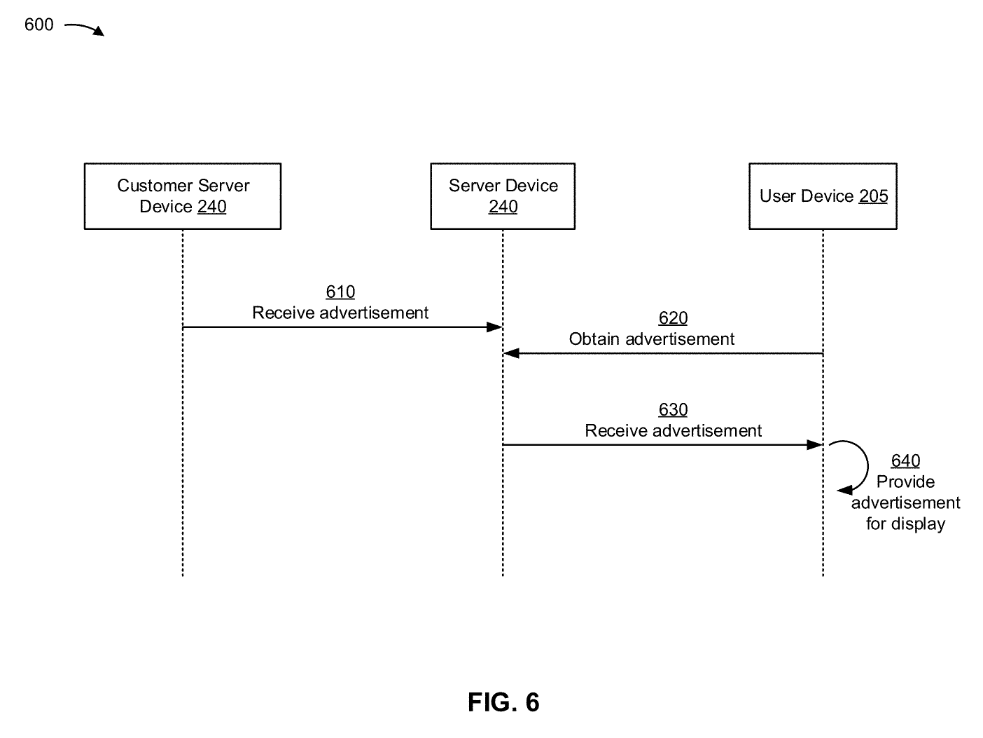

FIG. 6 is a call flow diagram of an example call flow 600 for dynamic configuration of user interface elements. FIG. 6 shows an example of obtaining advertisements to be used when configuring user interface elements of a user interface. As shown, call flow 600 can include a customer server device 240, server device 240, and user device 205.

As shown in FIG. 6, and by reference number 610, server device 240 (e.g., associated with a network provider that provides a content delivery network 245) can receive an advertisement to be provided for display from a customer server device 240. As shown by reference number 620, user device 205 can obtain the advertisement from server device 240 (e.g., based on determining that the advertisement is to be provided for display via a set of user interface elements). As shown by reference number 630, user device 205 can receive the advertisement from server device 240. As shown by reference number 640, user device 205 can provide the advertisement for display using a set of user interface elements.

In this way, user device 205 can provide an advertisement for display using a set of user interface elements.

As indicated above, FIG. 6 is provided merely as an example. Other examples are possible and can differ from what was described with regard to FIG. 6.

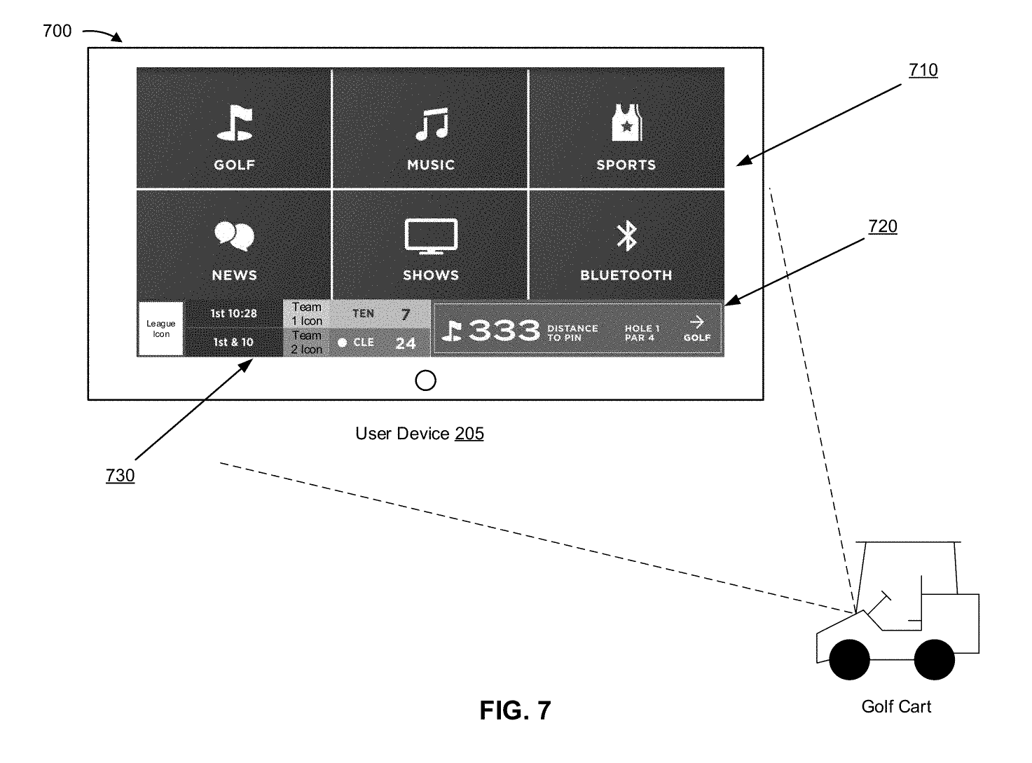

FIG. 7 is a diagram of an example implementation 700 relating to example process 400 shown in FIG. 4. FIG. 7 shows an example implementation where user device 205 is associated with a golf cart. In some implementations, user device 205 can be mounted in a dashboard of the golf cart. Additionally, or alternatively, user device 205 can be mounted from a roof of the golf cart within a cabin of the golf cart. Additionally, or alternatively, user device 205 can be mounted to a steering wheel, a seat, and/or the like of the golf cart.

As shown by reference number 710, user device 205 can provide a homepage user interface for display that permits a user of user device 205 to access various services via selection of icons associated with the services. As shown by reference number 720, a golf ticker user interface element can provide information related to a distance user device 205 is from a golf green and/or pin of a golf hole, a par of the golf hole, and/or the like. In some implementations, user device 205 can determine other golf-related information and/or can use the golf ticker user interface element to display the other information.

For example, user device 205 can determine and provide for display, via the golf ticker user interface element, information related to a club recommendation for a user of user device 205 (e.g., based on a distance to a golf hole from a location of user device 205, an average distance a user of user device 205 has previously hit golf balls using the same or different clubs based on information input by a user related to club usage and GPS locations for each hit, etc.), a wind speed and/or direction at a golf hole, whether a storm is within a threshold distance of the golf hole and/or golf course, distances and/or locations of hits of other golfers, and/or the like. As shown by reference number 730, a sports ticker user interface element can display sports-related information.

As indicated above FIG. 7 is provided merely as an example. Other examples are possible and can differ from what was described with respect to FIG. 7.

Although some implementations were described with respect to golfing and a golf cart, the implementations apply equally to other contexts, such as a vehicle navigation system, or contexts other than transportation.

Some implementations, described herein, provide a device that can process information from multiple different sources and can dynamically configure various sets of user interface elements based on the information. In this way, the device dynamically configures the various user interface elements in real-time, thereby improving use of a user interface. This conserves processing resources that would otherwise be consumed providing un-needed user interface elements for display, via selection of user interface elements that are not needed for a particular use (e.g., via accidental selection by a user of the user interface), and/or the like. In addition, this enhances a user experience of a user of the user interface via dynamic configuration of various sets of user interface elements for particular uses, particular needs, and/or the like.

The foregoing disclosure provides illustration and description, but is not intended to be exhaustive or to limit the implementations to the precise form disclosed. Modifications and variations are possible in light of the above disclosure or can be acquired from practice of the implementations.

As used herein, the term component is intended to be broadly construed as hardware, firmware, or a combination of hardware and software.

Some implementations are described herein in connection with thresholds. As used herein, satisfying a threshold can refer to a value being greater than the threshold, more than the threshold, higher than the threshold, greater than or equal to the threshold, less than the threshold, fewer than the threshold, lower than the threshold, less than or equal to the threshold, equal to the threshold, or the like.

Certain user interfaces have been described herein and/or shown in the figures. A user interface can include a graphical user interface, a non-graphical user interface, a text-based user interface, or the like. A user interface can provide information for display. In some implementations, a user can interact with the information, such as by providing input via an input component of a device that provides the user interface for display. In some implementations, a user interface can be configurable by a device and/or a user (e.g., a user can change the size of the user interface, information provided via the user interface, a position of information provided via the user interface, etc.). Additionally, or alternatively, a user interface can be pre-configured to a standard configuration, a specific configuration based on a type of device on which the user interface is displayed, and/or a set of configurations based on capabilities and/or specifications associated with a device on which the user interface is displayed.

To the extent the aforementioned embodiments collect, store, or employ personal information provided by individuals, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various encryption and anonymization techniques for particularly sensitive information.

It will be apparent that systems and/or methods, described herein, can be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware can be designed to implement the systems and/or methods based on the description herein.

Even though particular combinations of features are recited in the claims and/or disclosed in the specification, these combinations are not intended to limit the disclosure of possible implementations. In fact, many of these features can be combined in ways not specifically recited in the claims and/or disclosed in the specification. Although each dependent claim listed below can directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and can be used interchangeably with “one or more.” Furthermore, as used herein, the term “set” is intended to include one or more items (e.g., related items, unrelated items, a combination of related and unrelated items, etc.), and can be used interchangeably with “one or more.” Where only one item is intended, the term “one” or similar language is used. Also, as used herein, the terms “has,” “have,” “having,” or the like are intended to be open-ended terms. Further, the phrase “based on” is intended to mean “based, at least in part, on” unless explicitly stated otherwise.

What is claimed is:

1. A device, comprising:
one or more memories; and
one or more processors, communicatively coupled to the one or more memories, to:
receive information associated with dynamically configuring a set of user interface elements associated with a user interface;
process the information to determine a manner in which to configure one or more subsets of user interface elements, of the set of user interface elements,
the one or more subsets of user interface elements including:
a first subset of user interface elements related to displaying event-related information,
the first subset of user interface elements to display the event-related information for a threshold amount of time,
a second subset of user interface elements related to displaying location-based information,
a third subset of user interface elements related to navigating through one or more user interfaces,
a fourth subset of user interface elements related to a homepage user interface,
a fifth subset of user interface elements related to displaying an advertisement via the user interface, and
a sixth subset of user interface elements related to displaying live content via the user interface;
perform an action to cause the one or more subsets of user interface elements to be configured in the determined manner;
detect a modification to the information after performing the action; and
modify the manner in which the one or more subsets of user interface elements are to be configured based on the modification to the information.

2. The device of claim 1, where the one or more processors are further to:
determine a set of services to be provided via the device based on the information; and
where the one or more processors, when processing the information, are to:
process the information to determine the manner in which to configure the third subset of user interface elements related to navigating through the one or more user interfaces based on the set of services to be provided.

3. The device of claim 2, where the one or more processors, when processing the information, are to:
process the information to determine the manner in which to configure the fourth subset of user interface elements related to the homepage user interface based on the set of services to be provided.

4. The device of claim 1, where the one or more processors are further to:
determine whether a particular sport is in season using the information;
determine whether a sporting event associated with the particular sport is upcoming, in progress, or complete after determining whether the particular sport is in season; and
where the one or more processors, when processing the information, are to:
process the information to determine the manner in which to configure the first subset of user interface elements based on whether the sporting event is upcoming, in progress, or complete.

5. The device of claim 1, where the one or more processors, when processing the information, are to:
process the information to determine a quantity of characters included in other information related to an event that is to be displayed via the first subset of user interface elements; and
where the one or more processors are further to:
determine that the other information is to be provided for display via the first subset of user interface elements for the threshold amount of time based on the quantity of characters included the other information.

6. The device of claim 1, where the one or more processors, when processing the information, are to:
process the information to determine whether other information related to an event that is to be displayed via the first subset of user interface elements can be displayed within dimensions of the first subset of user interface elements; and
where the one or more processors are further to:
determine whether the other information is to be displayed in a static manner or in a scrolling manner based on determining whether the other information can be displayed within the dimensions of the first subset of user interface elements.

7. The device of claim 1, where the one or more processors, when processing the information, are to:
process the information to determine whether the device is a threshold distance from a golf green or a golf pin associated with a golf hole; and
determine the manner in which to configure the second subset of user interface elements based on whether the device is the threshold distance from the golf green or the golf pin,
the second subset of user interface elements to be used to display other information related to the golf hole.

8. A non-transitory computer-readable medium storing instructions, the instructions comprising:
one or more instructions that, when executed by one or more processors, cause the one or more processors to:
receive information associated with dynamically configuring a set of user interface elements associated with a user interface;
process the information to determine a manner in which to configure one or more subsets of user interface elements, of the set of user interface elements,
the one or more subsets of user interface elements including:
a first subset of user interface elements related to displaying sports-related information,
the first subset of user interface elements to display the sports-related information for a threshold amount of time,
a second subset of user interface elements related to displaying location-based information,
a third subset of user interface elements related to navigating through one or more user interfaces,
a fourth subset of user interface elements related to a homepage user interface,
a fifth subset of user interface elements related to displaying an advertisement, and
a sixth subset of user interface elements related to displaying live content via the user interface;
perform an action to cause the one or more subsets of user interface elements to be configured in the determined manner;
detect a modification to the information after performing the action; and
modify the manner in which the one or more subsets of user interface elements are to be configured based on the modification to the information.

9. The non-transitory computer-readable medium of claim 8, where the one or more instructions, that cause the one or more processors to process the information, cause the one or more processors to:
process the information to determine whether the live content to be provided for display via the sixth subset of user interface elements is live sports content; and
determine the manner in which to configure the sixth subset of user interface elements based on whether the live content to be provided for display is the live sports content.

10. The non-transitory computer-readable medium of claim 8, where the one or more instructions, that cause the one or more processors to process the information, cause the one or more processors to:
process the information to determine whether an event is upcoming, in progress, or complete; and
determine the manner in which to configure the first subset of user interface elements based on whether the event is upcoming, in progress, or complete.

11. The non-transitory computer-readable medium of claim 8, where the one or more instructions, that cause the one or more processors to process the information, cause the one or more processors to:
process the information to determine whether:
a first threshold amount of time prior to an event is satisfied, or
a second threshold amount of time after the event is satisfied; and
where the one or more instructions, when executed by the one or more processors, further cause the one or more processors to:
determine an amount of time other information related to the event is to be provided for display via the first subset of user interface elements based on determining whether the first threshold amount of time or the second threshold amount of time is satisfied.

12. The non-transitory computer-readable medium of claim 8, where the one or more instructions, that cause the one or more processors to receive the information, cause the one or more processors to:
receive the information that identifies a schedule related to the live content; and
where the one or more instructions, that cause the one or more processors to process the information, cause the one or more processors to:
process the information to determine the manner in which to configure the sixth subset of user interface elements based on the information that identifies the schedule related to the live content.

13. The non-transitory computer-readable medium of claim 8, where the one or more instructions, that cause the one or more processors to receive the information, cause the one or more processors to:
receive the information that identifies a set of advertisements to be provided for display via the fifth subset of user interface elements,
the information identifying a type of the set of advertisements; and
where the one or more instructions, that cause the one or more processors to process the information, cause the one or more processors to:
process the information to determine the manner in which to configure the fifth subset of user interface elements based on the type of the set of advertisements.

14. The non-transitory computer-readable medium of claim 8, where the one or more instructions, that cause the one or more processors to process the information, cause the one or more processors to:
process the information to determine the manner in which to configure the fourth subset of user interface elements based on the information identifying a set of services to be provided via a device.

15. A method, comprising:
receiving, by a device, information associated with dynamically configuring a set of user interface elements associated with a user interface;
processing, by the device, the information to determine a manner in which to configure one or more subsets of user interface elements, of the set of user interface elements,
the one or more subsets of user interface elements including:
a first subset of user interface elements related to displaying sports-related information,
the first subset of user interface elements to display the sports-related information for a threshold amount of time,
a second subset of user interface elements related to displaying location-based information,
a third subset of user interface elements related to navigating through one or more user interfaces,
a fourth subset of user interface elements related to a homepage user interface,
a fifth subset of user interface elements related to displaying an advertisement, and
a sixth subset of user interface elements related to displaying live content via the user interface;
performing, by the device, an action to cause the one or more subsets of user interface elements to be configured in the determined manner;
detecting, by the device, a modification to the information after performing the action; and
modifying, by the device, the manner in which the one or more subsets of user interface elements are to be configured based on the modification to the information.

16. The method of claim 15, where processing the information comprises:
processing the information to determine the manner in which to configure the first subset of user interface elements,
the information relating to an event that is upcoming, in progress, or complete; and
determining the manner in which to configure the first subset of user interface elements based on whether the event is upcoming, in progress, or complete.

17. The method of claim 15, further comprising:
determining a location of the device based on processing the information; and
determining the manner in which to configure the second subset of user interface elements based on the location of the device.

18. The method of claim 15, further comprising:
determining a type of the advertisement to be provided for display via the fifth subset of user interface elements based on processing the information; and
determining the manner in which to configure the fifth subset of user interface elements based on the type of the advertisement.

19. The method of claim 15, where performing the action comprises:
configuring the one or more subsets of user interface elements in the determined manner.

20. The method of claim 15, where performing the action comprises:
generating a set of instructions to cause the one or more subsets of user interface elements to be configured in the determined manner; and
providing the set of instructions to another device to cause the other device to configure the one or more subsets of user interface elements in the determined manner.
